(19) United States
(12) Patent Application Publication
(10) Pub. No.: US 2006/0188742 A1
(43) Pub. Date: Aug. 24, 2006

(54) Chamber component having grooved surface

(75) Inventors: Brian T. West, San Jose, CA (US); Maocheng Li, Fremont, CA (US); Hong Wang, Cupertino, CA (US)

Correspondence Address: JANAH & ASSOCIATES, P.C., 650 DELANCEY STREET, SUITE 106, SAN FRANCISCO, CA, 94547, US

(73) Assignee: Applied Materials, Inc.

(21) Appl. No.: 11/037,587

(22) Filed: Jan. 18, 2005

(51) Int. Cl. B44C 1/22; B60J 10/00; C25F 3/00; B21C 37/00; B21H 8/00

(52) U.S. Cl. 428/573; 216/11

(57) ABSTRACT

A substrate processing chamber component capable of being exposed to an energized gas in a process chamber has a component structure, and a surface on the structure with first and second spiral grooves, which can oppose one another. Process residues adhere to the surface during processing of a substrate in an energized gas to reduce contamination of the substrate.

### BACKGROUND

Embodiments of the present invention relate to components for a substrate processing chamber.

In the processing of substrates, such as semiconductor wafers and displays, a substrate is placed in a process chamber and exposed to an energized gas to deposit or etch material on the substrate. A typical process chamber comprises process components including an enclosure wall that encloses a process zone, a gas supply to provide a gas in the chamber, a gas energizer to energize the process gas to process the substrate, a substrate support, and a gas exhaust. The process chamber components can also comprise a process kit, which typically includes one or more parts that can assist in securing and protecting the substrate during processing.

During processing of a substrate in a process chamber, process residues are generated that can deposit on internal surfaces in the chamber. For example, process residues can deposit on surfaces including a substrate support surface, and surfaces of enclosure walls. In subsequent process cycles, the deposited process residues can “flake off” of the internal chamber surfaces to fall upon and contaminate the substrate. To solve this problem, the surfaces of components in the chamber are often textured to reduce the contamination of the substrates by process residues. Process residues adhere to these textured surfaces, and the incidence of contamination of the substrates by the process residues is reduced.

In one version, a textured component surface is formed by directing an electromagnetic energy beam onto a component surface to form depressions and protrusions to which the process deposits can better adhere. The textured component surface can also be provided by forming a textured coating on a component. However, even such textured component surfaces may not sufficiently reduce process residue build-up problems.

For example, a problem typically arises when relatively small or narrow textured features on the textured components, such as holes or depressions in the component surface, fill-up with process residues too quickly, requiring cleaning of the component after processing of only a few substrates. Also, a film of process residue can “bridge” or stop up holes or depressions in the textured component surface, limiting the amount of process residue that can accumulate on the component surface without flaking off. The “bridged” film may also not be as firmly held on the textured surface causing premature spalling from the surface. Thus, conventional textured surface components often do not allow a sufficiently large number of substrates to be processed before cleaning of the component is required, thereby reducing processing efficiency and increasing chamber downtime. Also, relatively small or narrow textured features can sometimes “lock” process residues within the small features, making them difficult to remove during component cleaning and refurbishing processes.

Accordingly, it is desirable to reduce flaking of accumulated process residues from components in a process chamber. It is furthermore desirable to allow increased amounts of process residue accumulation on component surfaces, with reduced bridging of holes or depressions on the component surface.

### SUMMARY

A chamber component is provided that is capable of being exposed to an energized gas in a substrate processing chamber has a component structure and a surface. The surface has first and second spiral grooves that oppose one another. Process residues adhere to the spiral grooves on the surface of the component structure during processing of a substrate in the energized gas in the substrate processing chamber, thereby reducing contamination of the substrate by the process residues. The spiral grooves can have a depth of at least about 0.25 mm. The component is fabricated by providing a component structure having a surface and machining opposing spiral grooves into the surface.

In another version, the chamber component has a component structure having a textured surface. The textured surface has a first textured pattern region having a plurality of first texture features that are spaced apart from one another and each have a first depth and first density, and a second textured pattern region having a plurality of second texture features that are spaced apart from one another and each have with a second depth and second density. At least one of the second depth and the second density is other than the first depth and the first density. Process residues adhere well to the surface during processing of a substrate to reduce contamination of the substrate.

### DRAWINGS

These features, aspects, and advantages of the present invention will become better understood with regard to the following description, appended claims, and accompanying drawings, which illustrate examples of the invention. However, it is to be understood that each of the features can be used in the invention in general, not merely in the context of the particular drawings, and the invention includes any combination of these features, where:

FIG. 1a is a partial sectional side view of an embodiment of a chamber shield having a surface with opposing spiral grooves formed therein;

FIG. 1b is a partial sectional side view of an embodiment of a ring-shaped chamber component having a surface with opposing spiral grooves formed therein;

FIG. 1c is a partial sectional side view of an embodiment of a chamber shield having first and second surface texture patterns;

FIG. 2 is a partial sectional side view of an embodiment of a chamber component having a groove being formed therein by a cutting blade;

FIG. 3 is a partial sectional side view of an embodiment of a grooved chamber component comprising rounded edges; and

FIG. 4 is a partial sectional side view of an embodiment of a process chamber having a component with a textured surface.

### DESCRIPTION

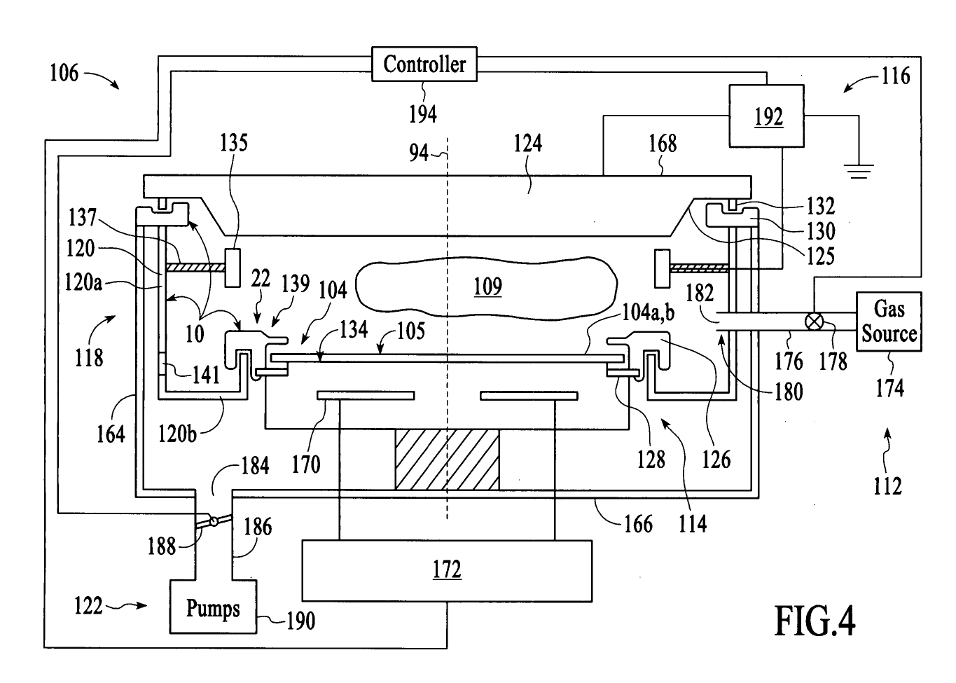

A substrate processing chamber 106 (shown in FIG. 4) comprises components 10 for processing a substrate 104a in an energized gas. One or more of the components 10 can comprise a component structure 11 that has a surface 22 that is textured, such that process residues generated during the processing of substrates 104a can adhere to the component surface 22 to reduce the contamination of processed substrates 104a from the process residues. The components 10 having the textured surface 22 can comprise for example a portion of a gas delivery system 112 that provides process gas in the chamber 106, a substrate support 114 that supports the substrate 104a in the chamber 106, a gas energizer 116 that energizes the process gas, chamber enclosure walls 118 and shields 120, and a gas exhaust 122 that exhausts gas from the chamber 106.

Referring to FIG. 4, which illustrates an exemplary version of a physical vapor deposition chamber 106, components 10 having the textured surface 22 can include a chamber enclosure wall 118, a chamber shield 120, a target 124, a target rim 125, a cover ring 126, a deposition ring 128, a support ring 130, insulator ring 132, a coil 135, coil support 137, shutter disk 104b, clamp shield 141, and a surface 134 of the substrate support 114. The components 10 having the textured surface 22 can also comprise components of chambers such as etching chambers, pre-clean chambers, ashing chambers, CVD chambers, and other chambers. The textured surface 22 of the components 20 can comprise a metal material, such as at least one of titanium, stainless steel, copper, tantalum, tungsten, and aluminum. The textured surface 22 can also comprise ceramic materials, such as at least one of aluminum oxide, aluminum nitride, silicon nitride, silicon oxide, quartz, silicon carbide, yttrium oxide, zirconium oxide and titanium oxide. Examples of Applied Materials part numbers that can be fabricated or treated to have the textured surface 22 include part numbers 0021-17718, 0200-00673. 0200-00674, 0021-17721, 0021-17719, 0021-17717 and 0021-17720.

In one version, the component 10 comprises a surface 22 that is textured to inhibit the flaking or spalling of process deposits from the surface 22 by reducing the average length and number of continuous sections 83 on the surface 22. Process deposits that build-up on excessively long continuous sections 83 may adhere to each other very strongly, and as a result may spall from the component 10 in a long residue strip, which can lead to the contamination of substrates being processed in the chamber 106. In contrast, it has been discovered that surface sections that are broken up by bumps or crevices, or other surface discontinuities, provide better adhesion of process residues to the surface and do not allow the residues to flake or spall away from the surface as readily.

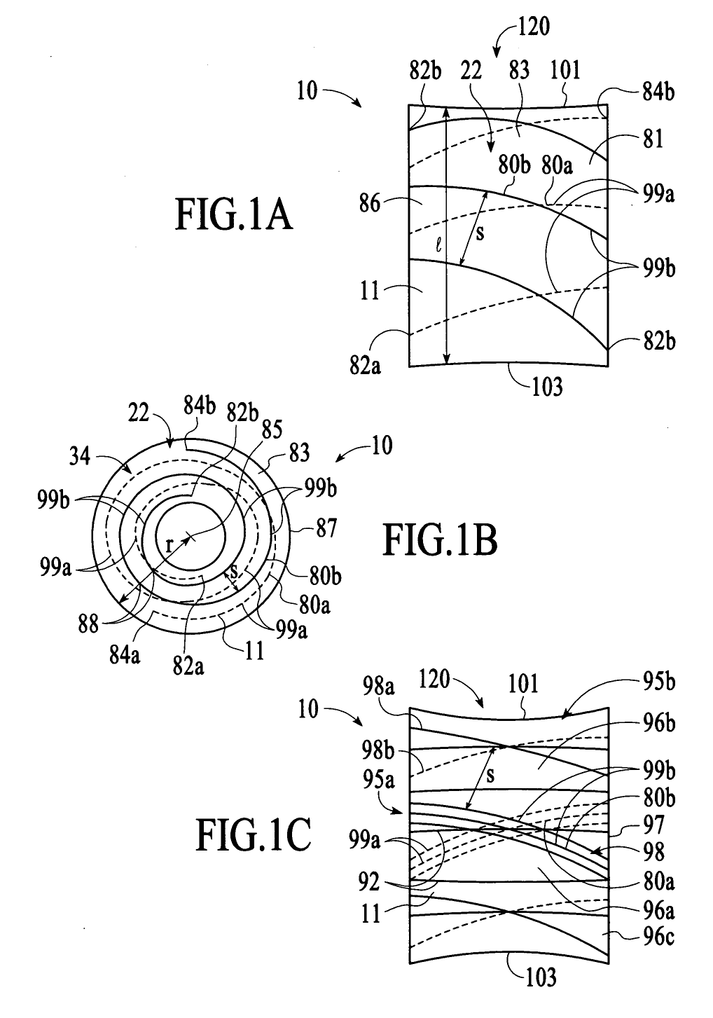

In one version, an improved surface 22 having a reduced number of excessively long continuous sections 83 is provided by forming first and second spiral grooves 80a,b, respectively, in the surface, as shown for example in FIGS. 1a and 1b. The spiral grooves 80a,b can oppose one another. For example, the grooves 80a,b can be left and right-handed grooves that travel in opposing directions, and can comprise opposing threads formed in the surface. In a preferred version, the opposing spiral grooves 80a,b comprise a right-handed spiral groove 80a that rotates clockwise about the surface 22, and a left-handed spiral groove 80b that rotates counterclockwise about the surface 22, as viewed from above. The spiral grooves 80a,b can cross and intersect each other, as shown for example in FIGS. 1a and 1b, to break up and shorten un-grooved portions 81 that are substantially continuous sections 83 of the component surface 22. In one version, the surface 22 comprising the spiral grooves 80a,b is substantially absent a continuous section 83 having a length or circumference between the grooves 80a,b of greater than about 0.1 cm (0.04 inches). For example, the average length or circumference of the continuous sections 83 may be less than about 0.05 cm (0.02 inches.) In one version, the length or circumference of the continuous sections 83 may be in the range of from a little over zero centimeters to no more than about 0.1 cm (0.04 inches.) In another version, the continuous sections 83 between the grooves 80a,b on the surface 22 may not exceed an area of about 0.1 cm² (1600 square thousandths of an inch), for example the area may be in the range of from about 0.001 cm² (225 square thousandths of an inch) to about 0.1 cm² (1600 square thousandths of an inch). The opposing spiral grooves 80a,b form a more discontinuous surface to improve the adhesion of process residues to the surface 22.

FIGS. 1a and 1b show embodiment of components 10 having opposing spiral groove configurations. For example, FIG. 1a shows an embodiment of a section of a cylindrically-shaped component 10, in this case a cylindrically-shaped section of a chamber shield 120, having the opposing spiral grooves 80a,b formed on the interior surface 22 of the component 10. In this embodiment, the opposing spiral grooves 80a,b extend vertically across the surface 22 of the shield 120 while spiraling about a central axis 94 of the shield 120, to form a helix of grooves spanning at least a portion of the shield surface 22. The central axis 94 of the shield 120 typically coincides with the central axis of the process chamber 106, as shown for example in FIG. 4. For example, a first spiral groove 80a can comprise a right-handed orientation, in which the spiral groove 80a rotates clockwise about the surface 22 of the component 10 with increasing length/turn of the spiral groove 80a. The second spiral groove 80b can comprise a left-handed orientation, in which the spiral groove rotates counterclockwise about the surface 22 of the component, also with increasing length/turn of the spiral groove. In one version, the spiral grooves 80a,b start at start points 82a,b located towards one end of the shield 120, such as at the bottom 103 of the shield 120, and rotate upwardly about the central axis of the shield 120 to end at a spiral end points 84a,b located towards an opposing end of the shield 120, such as the top 101 of the shield 120. A suitable helix angle formed by each of the grooves 80a,b with respect to the central axis 94 can be for example at least about 45°, such as from about 45° to about 75°, and even at least about 60°. A suitable spacing s between spiral arms 99a,b of each spiral groove 80a,b, may be from about 0.25 cm (0.1 inches) to about 1.3 cm (0.5 inches), such as about 0.6 cm (0.25 inches.)

FIG. 1b shows another embodiment of a component 10 having opposing spiral grooves 80a,b. In this embodiment, the component comprises ring-shaped component 10 having the opposing spiral grooves 80a,b formed on a top surface 34 of the component 10. The ring-shaped component 10 can comprise, for example, a component of a process kit 139, such as at least one of a retaining clamp, deposition ring 128, and cover ring 126. The opposing spiral grooves 80a,b each rotate about the surface 22 of the component 10 with increasing groove radius r, from a spiral start point 82a,b located towards the center 85 of the component 10, to a spiral stop point 84a,b located towards the periphery 87 of the component. In the version shown, the spiral grooves 80a,b are concentric with respect to the central axis 85 of the component 10, and the opposing spiral grooves 80a,b typically crisscross and intersect one another at numerous points on the surface 22 to break up continuous surface segments. A suitable spacing between the spiral arms 99a,b of each spiral groove 80a,b may be from about 0.25 cm (0.1 inches) to about 1.3 cm (0.5 inches), such as about 0.6 cm (0.25 inches.) Thus, the opposing spiral grooves 80a,b on the ring-shaped component form a substantially horizontal and outwardly spiraling pattern of grooves 80a,b that improves the adhesion of process residues to the component surface 22.

In yet another version, the surface 22 may further comprise one or more ring-shaped grooves 92, as shown for example in FIG. 1c, to further break-up continuous sections of the surface 22. The ring-shaped grooves 92 are typically concentric with and encircle the central axis of the component 10, such as the central axis 94 of the shield 120. The ring-shaped grooves 92 may be concentric with one another and spaced apart axially or radially across the surface 22. The ring-shaped grooves 92 also desirably traverse and intersect the opposing spiral grooves 80a,b at a plurality of points along the surface 22, to break-up any continuous linear or radial surface sections. In one version, the ring-shaped grooves 92 can be vertically spaced apart along the surface 22 of a cylindrically-shaped component 10, such as along the axial length l of the shield 120. In another version, the ring-shaped grooves 92 can be radially spaced apart along the surface 22 of a ring-shaped component 10, such as along the radius r of a ring-shaped component 10 of a process kit 139. A spacing between the ring-shaped grooves 92 is selected to provide optimum residue adhesion. For example, a suitable spacing between adjacent ring-shaped grooves 92 on a shield 120 may be from about 0.25 cm (0.1 inches) to about 1.3 cm (0.5 inches), such as about 0.6 cm (0.25 inches.)

The opposing spiral grooves 80a,b in the component 10 desirably comprise a depth in the surface 22 that is sufficiently high to improve the adhesion of process residues to the component 10. For example, a suitable depth of the opposing spiral grooves 80a,b in the surface 22 may be at least about 0.25 millimeters, and no more than about 1.5 mm, such as from about 0.25 mm to about 1.5 mm. The depth of the grooves 80a,b may typically be greater than a depth that could otherwise be formed by knurling, according to the material composition of the component 10. In one version, the depth of a first spiral groove 80a is different than the depth of the second spiral groove 80b. While the depth of the grooves 80a,b is desirably at least about 0.25 mm in at least one region of the surface 22, the grooves 80a,b may also be shallower than 0.25 mm in another region of the surface 22. Alternatively, the grooves 80a,b may substantially entirely comprise a depth of at least about 0.25 mm along the entire length of the grooves 80a,b. The first and second spiral grooves 80a,b may also comprise a different spacing between adjacent spiral arms 99a,b than each other.

In one version, the surface 22 comprises first and second textured features 98a,b, such as for example the opposing spiral grooves 80a,b, that form a first textured pattern 95a in a first textured pattern region 96a of the surface 22, and a second textured pattern 95b in a second textured pattern region 96b of the surface 22, as shown for example in FIG. 1c. For example, the first textured pattern 95a may comprise one or more of a first depth and first spacing between spiral arms 99a,b of each spiral groove 80a,b, that is other than that of the second depth and second spacing in the second textured pattern 95b. The density of the spiral arms 99a,b in the first textured pattern 95a may also be other than that in the second textured pattern 95b. In one version, the surface 22 comprises opposing spiral grooves 80a,b that vary in depth from a first depth in a first region 96a of the surface 22, to a second depth in a second region 96b of the surface 22. Varying the depth of the spiral grooves 80a,b across the surface 22 can allow the grooves to be optimized for the adhesion of residues in different chamber locations. For example, in regions that experience a high volume of process deposits, such as regions that are close to the process zone in the process chamber 106, the spiral grooves 80a,b, may comprise a greater depth to accommodate the larger number of residues. As another example, regions that do not experience a high residue deposition volume may comprise less deep, shallower grooves 80a,b to accommodate the lighter deposition volume. The depths can also be optimized according to the typical composition and structure of residue deposits that form in different regions of the chamber 106. The spacing and depths can also be optimized according to the type of component and the process for which it is being used.

The spacing s between spiral arms 99a,b in each opposing spiral groove 80a,b, and the number of the spiral arms 99a,b per area of surface 22, can also be varied across the surface 22 of the component 10 to provide optimum adhesion of residues in different textured pattern regions 96a,b of the component 10. For example, a closer spacing s between the spiral arms 99a,b and higher density of the spiral arms 99a,b can be provided in textured pattern regions 96a,b that experience heavy residue deposition, to better accommodate the large volume of process residues with a higher density of spiral groove arms 99a,b. A wider spacing s between spiral arms 99a,b and lower density of the spiral arms 99a,b may be provided in textured pattern regions 96a,b that typically experience a reduced residue deposition volume. Ring-shaped grooves 92 formed in the surface 22 may also vary in spacing and depth across the surface, according to the desired residue adhesion characteristics.

A version of a surface 22 having first and second textured patterns 95a,b on a section of a shield 120 is shown for example in FIG. 1c. In this embodiment, the spacing between adjacent spiral arms 99a,b in each spiral groove 80a,b is closer together in a first textured pattern region 96a of the surface 22, which is located towards the middle 97 of the shield 120 and is in close proximity to the process zone in the process chamber 106. A second textured pattern region 96b of the surface 22, located towards the top 101 of the shield 120, has a lower density of spiral arms 99a,b, with a greater spacing between the arms 99a,b, as this more remote region may experience a lower volume of process deposits. A third textured pattern region 96c located towards the bottom 103 of the shield 120 may similarly have a larger spacing between adjacent spiral arms 99a,b. The depths of the spiral arms 99a,b of each opposing spiral groove 80a,b may also vary from a larger depth towards the middle 97 of the shield 120, to shallower depths towards the top 101 and bottom 103 of the shield 120. In another version, a ring-shaped component 10, such as for example a deposition ring 12, comprises spiral arms 99a,b having greater depths at about the middle of the ring surface 22, where the highest level of deposition is experienced, and shallower spiral arms 99a,b having smaller depths towards the center 85 and periphery 87 of the ring-shaped component 10, where the deposition of residues may be lighter. In one version, the spiral arm pattern on the ring-shaped component 10 may generally vary from a “coarser” pattern about the middle of the surface 22 that has relatively deep and even wide arms 99a,b with a fairly large spacing therebetween, to a “finer” pattern towards the center 85 and periphery 87 of the ring-shaped component 10 that has relatively shallow and even thin arms 99a,b that are more closely spaced together.

In one version, a depth of the spiral arms 99a,b in the first textured pattern region 96a is at least about 2 times the depth in the second textured pattern region 96b, and a second spacing between adjacent spiral arms 99a,b in the second textured pattern region 96b is at least about 1.7 times the spacing in the first textured pattern region 96a. For example, a depth of the spiral arms 99a,b of each opposing spiral groove 80a,b, may vary from a first larger depth in a first textured pattern region 96a of at least about 0.8 mm (0.02 inches), such as from about 0.8 mm (0.03 inches) to about 1.3 mm (0.05 inches), to a second smaller depth in a second textured pattern region 96b of less than about 0.6 mm (0.025 inches), such as from about 0.4 mm (0.015 inches) to about 0.6 mm (0.025 inches.) A spacing s between adjacent spiral arms 99a,b in each opposing spiral groove 80a,b may vary from a first smaller spacing in a first textured pattern region 96a of less than about 1.5 mm, such as from about 1 mm (0.04 inches) to about 1.5 mm (0.06 inches), to a second larger spacing in a second textured pattern region 96b of at least about 1.8 mm (0.07 inches), such as from about 1.8 mm (0.07 inches) to about 2.8 mm (0.11 inches.) In one version, one or more of the depths and spacing varies from the first to the second values in a substantially continuous fashion, substantially without abrupt variations in the values.

The surface 22 comprising the opposing spiral grooves 80a,b can be formed by a suitable method, such as for example a machining method that is capable of carving and/or milling the opposing spiral grooves 80a,b into the surface 22. For example, the opposing spiral grooves 80a,b can be cut into the surface 22 of the component structure 11 via a computer numeric control (CNC) machining method. In the CNC method, the desired groove shapes and depths are programmed into a computer controller that controls a cutting device, such as for example a rotating blade, that cuts the grooves 80a,b into the surface 22. The computer controller comprises program code to direct the cutting device to cut away predetermined volumes and shapes of the component surface 22 to form the desired grooves 80a,b therein. Other methods of forming the desired groove shape can also be used which may be known to those of ordinary skill in the art. Other milling and cutting methods known to those of ordinary skill in the art may also be used to form the desired grooves, and other metal shaping methods known to those of ordinary skill in the art may also be used, such as for example laser cutting and bending methods.

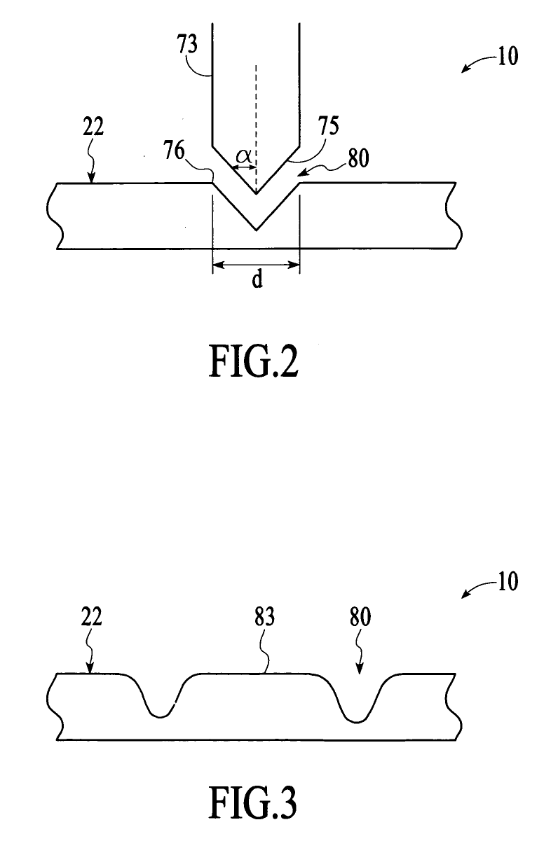

In one version, a CNC machining method traverses a cutting blade 73 comprising a rotating cutting blade 73 across the surface 22, in a pattern that forms the desired grooves 80a,b, as shown for example in FIG. 2. The rotating cutting blade 73 desirably comprises a double angled blade having a relatively small diameter d, such as a diameter of from about 1.3 cm (0.5 inches) to about 10 cm (4 inches), and also desirably comprises a relatively sharp included angle α, such as an angle of from about 45° to about 90° and even less than about 65°, such as about 60°, to form grooves 80a,b having the desired size. The rpm and pressure of the rotating cutting blade against the surface 22 can be selected to provide the desired groove shape. The cutting blade 73 may desirably comprise a radiused, rounded tip 75 to form a rounded groove 80a,b in the surface 22, and to reduce the incidence of microcracking and fracturing of the surface 22. For surfaces 22 comprising ceramics, the cutting blade 73 may comprise a grinding wheel with a suitable abrasive, such as for example a diamond coated grinding tool.

In another version, the CNC machining method traverses a cutting blade 73 comprising a non-rotating cutting edge across the surface 22 to form the desired groove shapes and sizes. The non-rotating cutting edge can be traversed across the surface 22 a desired number of times, with a pre-selected pressure against the surface 22, until grooves 80a,b having the desired shape and size have been formed. The cutting blade 73 comprises a material having a high hardness to abrade and cut into the component surface 22. For example, for a component having a metal surface 22, the cutting blade 23 may comprise a tip 75 made of tungsten carbide. For a component having a ceramic surface 22, the cutting blade 23 can comprise at least one of diamond and boron carbide. Alternatively, the grooves 80a,b can be formed in a soft ceramic preform before sintering the preform, to reduce the likelihood of cracking or breaking of the ceramic during groove formation. The CNC method allows for better control of the final groove shape by allowing the desired shape and parameters to be entered into the CNC computer program, such that the CNC computer can efficiently and automatically evaluate the correct machining parameters and perform the proper cutting steps to form the grooves 80a,b.

In one version, the surface 22 is further treated after forming the opposing spiral grooves 80a,b, to round-off the edges of the grooves to remove the sharp edges 76, which can include edges, corners and other sharp transitions from the surface 22. The removal of sharp edges 76 is desirable to reduce spalling or flaking of accumulated process residues from the component surface 22. The sharp edges 76 of the grooves 80a,b act as stress concentrators that cause breaks and cracks in the overlying residue deposit film, which eventually result in residue flakes that deposit upon and contaminate the substrate. In one version, as shown for example in FIG. 3, the component surface 22 is substantially absent sharp edges 76. The surface 22 can be treated to remove the sharp edges 76 for example by chemical etching, electrochemical graining, or grit blasting of the surface 22. For example, in the chemical etching method, the surface 22 comprising the grooves 80a,b may be immersed in a solution of chemical etchant, such as for example at least one of HF or HNO₃, to erode the sharp edges 76 and edges. In the electrochemical graining method, the surface 22 is immersed in an electrochemical graining bath solution, such as a solution of HCl, and a current is passed through the solution to electrochemically erode away the sharp edges and edges on the surface 22. In the grit blasting method, grit particles are propelled towards the surface 22 using compressed air to remove the sharp edges 76. Examples of suitable grit blasting and electrochemical graining processes and parameters are described in U.S. patent application Ser. No. 10/863,151 to Brueckner et al, entitled “Textured Chamber Surface,” which was filed on Jun. 7, 2004, and is commonly assigned to Applied Materials, and which is herein incorporated by reference in its entirety. In one version, the area of continuous sections 83 between the grooves 80a,b is kept sufficiently small such that these sections 83 between the grooves may be substantially rounded to form arc-like surface segments between the grooves 80a,b. For example, the area of each continuous section 83 may be less than about 0.6 mm² (100 square thousandths of an inch.) Various combinations of these methods as would be apparent to one of ordinary skill in the art are also possible.

The surface 22 can also be treated to provide one or more roughened regions 86. For example, the surface 22 can be treated to roughen the continuous sections 83 of the surface 22 between the opposing spiral grooves 80a,b, to enhance the adhesion of process residues to these sections. A suitable average surface roughness of the roughened regions 86 may be at least about 3.2 micrometers (125 microinches), such as from about 1.6 micrometers (63 microinches) to about 12.5 micrometers (500 microinches.) The surface 22 can be roughened by, for example, at least one of electrochemical graining and grit blasting of the surface. In one version, the surface roughening step is performed separately from the removal and rounding of sharp edges 76. In another version, the regions 86 of the surface 22 are roughened to the desired surface roughness during the step performed to round the sharp edges 76.

Components 10 having the surface 22 comprising the opposing spiral grooves 80a,b provide several advantages over other textured component parts. For example, the surfaces 22 comprising the spiral grooves 80a,b having a greater surface roughness than those of surfaces roughened by grit blasting or electron beam scanning alone. The repeating pattern of the spiral grooves 80a,b, which may comprise a periodic groove pattern, minimizes local stresses in a deposited residue film to provide better adhesion. The rounded edges 76 and other edges on the surface also help reduce localized microcracking of deposited residue films to inhibit spalling of the films. Also, the component surface 22 having the spiral grooves 80a,b can be easier to clean than other surfaces, such as surfaces formed by scanning an electron beam, because the open spiral grooves 80a,b allow for easy removal of residue therefrom. This may be especially true for electrochemical cleaning methods, such as for example the cleaning method described in U.S. Pat. No. 10/870,716 to Wang et al, entitled “Electrochemical Removal of Tantalum-Containing Materials,” commonly assigned to Applied Materials and filed on Jun. 17, 2004, which is herein incorporated by reference in its entirety. Also, the flexibility of the method allows for optimizing the spiral grooves to have different depths and different densities in varying regions of the surface, and even optimizing for different components. Furthermore, the mechanical cutting method of forming the grooves 80a,b should be applicable to components 10 having metal surfaces 22, as well as components having ceramic surfaces 22. Accordingly, the method and component having the opposing spiral grooves provides several advantages in the optimization of the component parts for the processing of substrates 104a.

In one version, a suitable process chamber 106 having a component 20 with the textured surface 22 is shown in FIG. 4. The chamber 106 can be a part of a multi-chamber platform (not shown) having a cluster of interconnected chambers connected by a robot arm mechanism that transfers substrates 104a between the chambers 106. In the version shown, the process chamber 106 comprises a sputter deposition chamber, also called a physical vapor deposition or PVD chamber, which is capable of sputter depositing material on a substrate 104a, such as one or more of tantalum, tantalum nitride, titanium, titanium nitride, copper, tungsten, tungsten nitride and aluminum. The chamber 106 comprises enclosure walls 118 that enclose a process zone 109 and that include sidewalls 164, a bottom wall 166 and a ceiling 168. A support ring 130 can be arranged between the sidewalls 164 and ceiling 168 to support the ceiling 168. Other chamber walls can include one or more shields 120 that shield the enclosure walls 118 from the sputtering environment.

The chamber 106 comprises a substrate support 114 to support the substrate in the sputter deposition chamber 106. The substrate support 114 may be electrically floating or may comprise an electrode 170 that is biased by a power supply 172, such as an RF power supply. The substrate support 114 can also support other wafers 164 such as a moveable shutter disk 104b that can protect the upper surface 134 of the support 114 when the substrate 104a is not present. In operation, the substrate 104a is introduced into the chamber 106 through a substrate loading inlet (not shown) in a sidewall 164 of the chamber 106 and placed on the support 114. The support 114 can be lifted or lowered by support lift bellows and a lift finger assembly (not shown) can be used to lift and lower the substrate onto the support 114 during transport of the substrate 104a into and out of the chamber 106.

The support 114 may also comprise one or more rings, such as a cover ring 126 or deposition ring 128, that cover at least a portion of the upper surface 134 of the support 114 to inhibit erosion of the support 114. In one version, the deposition ring 128 at least partially surrounds the substrate 104a to protect portions of the support 114 not covered by the substrate 104a. The cover ring 126 encircles and covers at least a portion of the deposition ring 128, and reduces the deposition of particles onto both the deposition ring 128 and the underlying support 114.

A process gas, such as a sputtering gas, is introduced into the chamber 106 through a gas delivery system 112 that includes a process gas supply comprising one or more gas sources 174 that each feed a conduit 176 having a gas flow control valve 178, such as a mass flow controller, to pass a set flow rate of the gas therethrough. The conduits 176 can feed the gases to a mixing manifold (not shown) in which the gases are mixed to form a desired process gas composition. The mixing manifold feeds a gas distributor 180 having one or more gas outlets 182 in the chamber 106. The process gas may comprise a non-reactive gas, such as argon or xenon, which is capable of energetically impinging upon and sputtering material from a target. The process gas may also comprise a reactive gas, such as one or more of an oxygen-containing gas and a nitrogen-containing gas, that is capable of reacting with the sputtered material to form a layer on the substrate 104a. Spent process gas and byproducts are exhausted from the chamber 106 through an exhaust 122 which includes one or more exhaust ports 184 that receive spent process gas and pass the spent gas to an exhaust conduit 186 in which there is a throttle valve 188 to control the pressure of the gas in the chamber 106. The exhaust conduit 186 feeds one or more exhaust pumps 190. Typically, the pressure of the sputtering gas in the chamber 106 is set to sub-atmospheric levels.

The sputtering chamber 106 further comprises a sputtering target 124 facing a surface 105 of the substrate 104a, and comprising material to be sputtered onto the substrate 104a, such as for example at least one of tantalum and tantalum nitride. The target 124 can be electrically isolated from the chamber 106 by an annular insulator ring 132, and is connected to a power supply 192. The target 124 may comprise a target backing plate having a target rim 125 that is exposed in the chamber 106. The sputtering chamber 106 also has a shield 120 to protect a wall 118 of the chamber 106 from sputtered material. The shield 120 can comprise a wall-like cylindrical shape having upper and lower shield sections 120a, 120b that shield the upper and lower regions of the chamber 106. In the version shown in FIG. 4, the shield 120 has an upper section 120a mounted to the support ring 130 and a lower section 120b that is fitted to the cover ring 126. A clamp shield 141 comprising a clamping ring can also be provided to clamp the upper and lower shield sections 120a,b together. Alternative shield configurations, such as inner and outer shields, can also be provided. In one version, one or more of the power supply 192, target 124 and shield 120, operate as a gas energizer 116 that is capable of energizing the sputtering gas to sputter material from the target 124. The power supply 192 applies a bias voltage to the target 124 with respect to the shield 120. The electric field generated in the chamber 106 from the applied voltage energizes the sputtering gas to form a plasma that energetically impinges upon and bombards the target 124 to sputter material off the target 124 and onto the substrate 104a. The support 114 having the electrode 170 and support electrode power supply 172 may also operate as part of the gas energizer 116 by energizing and accelerating ionized material sputtered from the target 124 towards the substrate 104a. Furthermore, a gas energizing coil 135 can be provided that is powered by a power supply 192 and that is positioned within the chamber 106 to provide enhanced energized gas characteristics, such as improved energized gas density. The gas energizing coil 135 can be supported by a coil support 137 that is attached to a shield 120 or other wall in the chamber 106.

The chamber 106 is controlled by a controller 194 that comprises program code having instruction sets to operate components of the chamber 106 to process substrates 104a in the chamber 106. For example, the controller 194 can comprise a substrate positioning instruction set to operate one or more of the substrate support 114 and substrate transport to position a substrate 104a in the chamber 106; a gas flow control instruction set to operate the flow control valves 178 to set a flow of sputtering gas to the chamber 106; a gas pressure control instruction set to operate the exhaust throttle valve 188 to maintain a pressure in the chamber 106; a gas energizer control instruction set to operate the gas energizer 116 to set a gas energizing power level; a temperature control instruction set to control temperatures in the chamber 106; and a process monitoring instruction set to monitor the process in the chamber 106.

Although exemplary embodiments of the present invention are shown and described, those of ordinary skill in the art may devise other embodiments which incorporate the present invention, and which are also within the scope of the present invention. For example, other retaining clamp configurations other than the exemplary ones described herein can also be provided. Also, the retaining clamp may be a part of process chambers other than those described. Also, other chamber components besides those specifically described could be textured according to one of the above-described methods. Furthermore, relative or positional terms shown with respect to the exemplary embodiments are interchangeable. Therefore, the appended claims should not be limited to the descriptions of the preferred versions, materials, or spatial arrangements described herein to illustrate the invention.

What is claimed is:

1. A component capable of being exposed to an energized gas in a substrate processing chamber, the component comprising:
(a) a component structure having a surface comprising first and second spiral grooves that oppose one another,
whereby process residues adhere to the spiral grooves on the surface of the component structure during processing of a substrate in the energized gas in the substrate processing chamber, thereby reducing contamination of the substrate by the process residues.

2. A component according to claim 1 wherein the first and second spiral grooves each comprise a helix angle of at least about 45 degrees.

3. A component according to claim 1 wherein the first and second spiral grooves each have a depth of at least about 0.25 mm.

4. A component according to claim 3 wherein the first and second spiral grooves each have a depth of no more than about 1.5 mm.

5. A component according to claim 1 wherein the first and second spiral grooves have a first spacing in a first region of the surface, and a second spacing in a second region of the surface.

6. A component according to claim 1 wherein the first and second spiral grooves have a first depth in a first region of the surface, and a second depth in a second region of the surface.

7. A component according to claim 1 wherein the surface further comprises ring-shaped grooves which are concentric to one another and spaced apart axially or radially across the surface.

8. A component according to claim 1 wherein the edges of the first and second grooves are rounded.

9. A component according to claim 1 wherein the surface comprises a roughened region having an average surface roughness of from about 1.6 micrometers to about 12.5 micrometers.

10. A component according to claim 1 wherein the surface comprises un-grooved portions between the first and second spiral grooves that are substantially continuous sections, the un-grooved portions having a dimension of less than about 0.1 cm.

11. A component according to claim 1 comprising at least a portion of a substrate support, chamber enclosure walls, process kit, shields, gas energizer, gas supply and gas exhaust.

12. A substrate processing chamber comprising the component of claim 1, the chamber comprising a substrate support, a gas energizer, a gas supply, and a gas exhaust.

13. A chamber component capable of being exposed to an energized gas in a substrate processing chamber, the component comprising:
(a) a component structure having a textured surface comprising:
(i) a first textured pattern region having first textured features that are spaced apart from one another and that each have a first depth and first density, and
(ii) a second textured pattern region having second textured features that are spaced apart from one another and that each have a second depth and second density,
wherein at least one of the second depth and the second density is other than the first depth and the first density,
whereby process residues adhere to the surface during processing of a substrate to reduce contamination of the substrate.

14. A component according to claim 13 wherein the first textured features comprise a first spiral groove having spiral arms with the first depth or spacing, and wherein the second textured features comprise a second spiral groove having the second depth or spacing.

15. A component according to claim 14 wherein the first or second spiral grooves each comprise spiral arms that continuously change depth from at least about 0.8 mm in the first region, to a second depth of at less than about 0.6 mm in the second region, and continuously change spacing from a first spacing of less than about 1.5 mm in the first region to a second spacing of at least about 1.8 mm in the second region.

16. A component according to claim 14 wherein the first and second spirals grooves oppose one another.

17. A substrate processing chamber comprising the component of claim 13, the chamber comprising a substrate support, a gas energizer, a gas supply, and a gas exhaust.

18. A method of fabricating a component for a substrate processing chamber, the method comprising:
(a) providing a component structure having a surface; and
(b) machining into the surface, first and second spiral grooves that oppose one another, each of the grooves having a depth of at least about 0.25 mm.

19. A method according to claim 18 wherein (b) comprises machining the first and second spiral grooves by traversing a cutting blade across the surface.

20. A method according to claim 19 comprising traversing a rotating cutting blade having an included angle of from about 45° to about 90°.

21. A method according to claim 18 wherein (b) comprises machining first and second spiral grooves that each have a helix angle of at least about 45°.

22. A method according to claim 18 wherein (b) comprises machining first and second spiral grooves comprising spiral arms having (i) a first depth and first spacing between adjacent arms in a first region of the surface, and (ii) a second depth and second spacing between adjacent arms in a second region of the surface.

23. A method according to claim 18 further comprising machining first and second spiral grooves that each comprise plurality of ring-shaped grooves that are concentric, and spaced apart axially or radially across the surface.

24. A method according to claim 18 further comprising rounding edges of the first and second grooves by at least one of chemical etching, electrochemical graining and grit blasting.

25. A method according to claim 18 further comprising roughening the surface to provide roughened regions having a surface roughness average of from about 1.6 micrometers to about 12.5 micrometers.
